(19) United States
(12) Patent Application Publication
(10) Pub. No.: US 2023/0368071 A1
(43) Pub. Date: Nov. 16, 2023

(54) METHOD OF AGGREGATING MODELS

(71) Applicant: SAMSUNG ELECTRONICS CO., LTD., Suwon-si (KR)

(72) Inventors: Mehmet Kerim YUCEL, Staines (GB); Mete OZAY, Staines (GB); Albert SAA-GARRIGA, Staines (GB); Bruno MANGANELLI, Staines (GB)

(73) Assignee: SAMSUNG ELECTRONICS CO., LTD., Suwon-si (KR)

(21) Appl. No.: 18/104,002

(22) Filed: Jan. 31, 2023

(30) Foreign Application Priority Data
May 10, 2022 (GB) 2206843.1

(51) Int. Cl. G06N 20/00; G06T 7/11

(52) U.S. Cl. CPC G06N 20/00; G06T 7/11; G06T 2207/20104; G06T 2207/20081

(57) ABSTRACT

A computer-implemented federated learning method is disclosed. The method comprises: for each of a number, n, of clients: determining a diversity score of a dataset corresponding to that client for training a machine learning model, wherein the diversity score is a measure of dataset variability; aggregating, weighted by the respective diversity score, models corresponding to each of the clients; and sending the aggregated model to at least one receiving client.

### CROSS REFERENCE TO RELATED APPLICATION

This application is based on and claims priority to United Kingdom Patent Application No. 2206843.1 filed on May 10, 2022, in the United Kingdom Intellectual Property Office, the contents of which are incorporated herein by reference.

### BACKGROUND

### Field

The present invention relates to a method of aggregating models using federated learning.

### Description of Related Art

Machine learning is a powerful tool which can be used to identify patterns in a data sample. Machine learning models can be trained on a dataset to classify certain patterns or characteristics within the dataset, allowing the identification of a pattern or characteristic when the model is applied to a new data sample. Machine learning is limited by the type and quantity of data samples within a dataset that the model is trained on. If a machine learning model is being trained on a device such as a smartphone, handset, or tablet, it may only have access to a dataset which is local to the device, for example, for security or connectivity reasons. Therefore, the diversity of the dataset may limit what the machine learning model is capable of identifying.

In one example, images may be stored on a smartphone, handset, or tablet from either a camera or downloaded from the Internet. A machine learning model may be trained on this set of images (dataset) to identify patterns, objects, or other characteristics in the images. One characteristic which may be identified are the location of shadows in images.

Existing shadow detection methods are not mobile-deployment (e.g. a smartphone) friendly for a variety of reasons, including the following. The model sizes are large relative to the sizes of models for other typical image analysis tasks. The runtime of typical shadow detection models cannot reach real-time, that is, there may be significant processing time when the model is executed by a user, resulting in a noticeable delay before a result is obtained.

Further, relatively large memory consumption during inference can render such methods unusable on-device. For example, the state-of-the-art detection model (on SBU dataset) is around 170 MB in size (Chen, Zhihao, et al. “A multi-task mean teacher for semi-supervised shadow detection.” Proceedings of the IEEE/CVF Conference on Computer Vision and Pattern Recognition. 2020), and alternative models can reach 300 MB in size. Lightweight detectors use probabilistic models for final refinement stage, introducing additional computational load (see Chen, Zhihao, et al. and also Zhu, Lei, et al. “Mitigating Intensity Bias in Shadow Detection via Feature Decomposition and Reweighting.” Proceedings of the IEEE/CVF International Conference on Computer Vision. 2021), and thus may use more power, draining the battery of a handheld device such as a smartphone.

There is no known lightweight shadow detection model, which is suitable for on-device deployment which also has the necessary privacy considerations. Existing methods lack generalization, due to the fact that available datasets are extremely small in size. For example, the SBU dataset is 5,000 images in total, and the ISTD dataset is 2,000 images in total.

Synthetically generated data, where shadows are superimposed on real images, are not geometry-aware since the location of the shadow forming object may not be known. This leads to poor results since the networks do not learn about geometry (e.g. the position of the shadow-causing object), but only the colour information, that is, the difference in shades of the pixels in regions where the shadow has been cast compared to regions of the image lacking shadow.

There are many use cases which are required to achieve true generalization in multiple different domains. Currently, there are no datasets which exist for such scenarios. Such domains include: indoor scenes with multiple light sources; outdoor scenes with multiple light sources; complex shadows with varying intensities; and night time scenes with multiple light sources; varying light colours.

### SUMMARY

According to a first aspect of the invention, there is provided a computer-implemented federated learning method. The method comprises, for each of a number, n, of clients: determining a diversity score of a dataset corresponding to that client for training a machine learning model, wherein the diversity score is a measure of dataset variability, aggregating, weighted by the respective diversity score, models corresponding to each of the clients, and sending the aggregated model to at least one receiving client.

Thus, the aggregated model accounts for the diversity of the clients' models based on the clients' datasets. This may mean that no one particular type of data within the dataset is over represented resulting in a biased or overtrained model. In other words, the aggregated model may result in a less biased model. This may allow for diversity-aware federated learning.

Aggregating may comprise averaging the diversity score weighted model weights for n clients.

The receiving client may be one of the n clients.

The diversity score may also be referred to as a first score or first identity.

Aggregating models corresponding to each of the clients may comprise, for each of the number, n, of clients: assigning each client to a cluster based on one or more dataset attributes. For each cluster, generating aggregated cluster weights by aggregating, weighted by the respective diversity score, models corresponding to each of the clients, and aggregating the aggregated cluster weights.

Clustering clients according to one or more dataset attributes may allow for hierarchical, cluster-based federated learning which is also diversity-aware. By first aggregating model weights obtained from datasets with similar attributes, and then aggregating these weights, more efficient distributed learning can be achieved.

Assigning each client to a cluster may comprise assigning a clustering identity to the dataset used to train the model.

The clustering identity may also be referred to as a second identity. The clustering identity may be based on, for example, dataset location, domain (i.e. food, document, outdoor), time (e.g. time of day), diversity score and the like.

Assigning the clustering identity to the dataset may comprise calculating a vector of softmax probabilities or extracting an embedding vector from a classification model, for example, a deep neural network.

The vector of softmax probabilities may be a Kᵢ-dimensional vector where Kᵢ is the number of classes for the i^{th} client for i=1, 2, . . . , n. The embedding vector may be a Dᵢ-dimensional vector for the i^{th} client for i=1, 2, . . . , n.

Thus, the dataset of each client may be represented by a clustering identity. The clustering identity may be assigned by inputting a client's dataset into a pretrained classification network and then extracting either the softmax probabilities and/or the embedding vectors. Any suitable classification model may be used to provide an identity for each client's dataset.

The softmax probabilities may be generated using the equation:

$${σ ( {x}_{i} )}_{k} = \frac{{e}^{{x}_{k}}}{{\sum }_{j = 1}^{{K}_{i}} {e}^{{x}_{j}}}$$

for k=1, 2, . . . , Kᵢ and xᵢ=(x₁, x₂, . . . , x_{K}_{ᵢ}) at the client.

The dataset may have been used for training a local model cached on a client.

The method may further comprise, for each of the n clients: applying a differential privacy function to the diversity score weighted model weight.

The privacy function may be a simple function that adds random noise to the score weighted model weight. Thus, the privacy of data from a client is maintained as no identifiable information is shared with another client. Further, the privacy function may also protect against malicious parties, for example, in the potential case of data breach (i.e. model weights can be stolen).

The aggregation step(s) may be performed on one of the number, n, of clients.

The aggregation step(s) may be performed on a central server.

The dataset used to train the model may comprise image data.

For example, the image data may be a photo, e.g. a digital photo, comprising a region representing a shadow cast by an object.

The dataset used to train the model may comprise an input provided by a user.

For example, the input provided by a user may be an indication of an object, or the location of a shadow or an occlusion.

The dataset may comprise a mask.

The mask may indicate a region, area or subset of the dataset. The mask may be a shadow mask for an image that represents an area or region of an image which indicates a shadow cast over it.

Determining the diversity score of the dataset may comprise: determining a scene identity for a subset of data of the dataset or a data sample.

The subset of the dataset may be a data sample. That is, a scene identity, may be determined for each of the data samples before they are added to a dataset, and the scene identities are stored or used to update the diversity score whenever a new data sample/mask pair are added to the dataset. Scene identities may be determined by a scene understanding model, for example, a neural network model.

The diversity score may be determined by combining the scene identities from a plurality of subsets of data or data samples, for example, by averaging the scene identities, or using other descriptive statistics, the mean and standard deviation, variance and the like, of scene identities of the data samples in the dataset.

The scene identity may also be referred to as a second identity.

The scene identity may be determined by calculating a vector of softmax probabilities or extracting feature representations, for example, an embedding vector (e.g. a Dᵢ-dimensional vector) from the model (e.g. a network model). The vector of softmax probabilities may be a Kᵢ-dimensional vector.

In response to a trigger condition, the method may further comprise, for each data sample: determining a confidence score of that data sample, adding the data sample to the dataset if the confidence score is above a threshold, and discarding the data sample if the confidence score is below the threshold.

In this way, data samples with a high confidence of accurate data will be added to the dataset, with data samples with low confidence of accurate data being discarded.

In response to a trigger condition, the method may further comprise for each data sample: determining a first confidence score for that data sample; augmenting that data sample; determining a second confidence score for the augmented data sample; discarding the data sample if the first and second confidence scores are above a first threshold distance; if the first confidence score is above a second threshold, adding the data sample to the dataset; and if the first confidence score is below the second threshold, discarding the data sample.

The trigger condition may be, for example, receiving one or more new data samples; one or more new data samples being available, or an input by a user.

Determining the confidence score of the data sample may further comprise determining the softmax probability for the data sample.

For example, if the data sample is an image, the softmax probability may be determined for each pixel in the image. The softmax probabilities for each pixel of an image may be averaged.

In response to a trigger condition, the method may further comprise for each data sample: determining whether the data sample is added to the dataset by comparing an attribute of the data sample to a corresponding attribute a subset of data in the dataset.

For example, if attributes of the data sample and attributes of a subset of data in the dataset have a distance below a threshold in an attribute space, then they may be too similar and therefore result in a low diversity score and in turn result in an overtrained model for data having that attribute. For example, if the data sample is an image of a document having a region indicating a shadow, and the dataset already includes one or more of similar images, then the data sample may be discarded.

The method may further comprise: if the distance between the attribute of the data sample and corresponding attribute of the dataset is below a threshold, discarding the data sample; and if the distance between the attribute of the data sample and corresponding attribute of the dataset is above a threshold, adding the data sample to the dataset.

Thus, if the dataset already contains a subset of data similar to the data sample, the data sample can be discarded and the diversity of the dataset is maintained.

The attribute may be, for example, embedding vectors to determine whether the data sample and a subset of data are similar. For example, an image embedding vector can be used to assess the similarity of two images.

The attribute may be location data, for example, mask location data indicating the location of an object or shadow in an image.

The method may further comprise determining that there is sufficient storage available to store the data sample when added to the dataset.

It may also be determined that a data sample is to be removed from the dataset based on an attribute of the existing data sample in the dataset and the corresponding attribute of a newly available data sample. For example, if a newly available data sample is of a higher value to the dataset, e.g. by increasing the dataset's diversity, then an existing data sample may be removed from the dataset.

According to a second aspect of the invention, there is provided a method comprising: receiving an image comprising a region indicating a shadow; identifying the region of the image indicating the shadow using the aggregated model of the first aspect.

Identifying the region of the image indicating the shadow may further comprise receiving an input from a user identifying the location of a shadow in the image.

Inputs from a user may be in the form of a mask which can be represented with Gaussian, Euclidian, Cosine or any other (distance) map. The mask may be integrated into multiple layers of the (decoder) network, by downsampling when necessary.

The method may further comprise displaying the image and a representation of the region of the image indicating the shadow.

The method may further comprise: identifying a second region of the image indicating the shadow using a second input from a user identifying or refining the location of a shadow in the image.

The method may be a computer implemented method.

According to a third aspect of the invention, there is provided a computer program comprising instructions which when executed by one or more processors causes the one or more processors to perform the method of either the first or second aspect.

According to a fourth aspect of the invention, there is provided a computer program product comprising a computer-readable medium storing the computer program of the third aspect.

According to a fifth aspect of the invention, there is provided a module configured to perform the method of either the first or second aspect.

The module may be a hardware module.

According to a sixth aspect of the invention, there is provided a monolithic integrated circuit comprising: a processor subsystem comprising at least one processor and memory; and the module of the fifth aspect.

According to a seventh aspect of the invention, there is provided a device comprising: the module of the fifth aspect; and at least one sensor for providing a data sample.

The sensor may be a camera, for example, a digital camera.

The device may be a tablet or smartphone.

According to an eighth aspect of the invention there is provided a computer system comprising: memory; and at least one processing unit; wherein the memory stores the dataset of the first or second aspect and the at least one processing unit is configured to perform the method of either the first or the second aspect.

According to a ninth aspect of the invention, there is provided a method comprising training a machine learning model using the dataset of the first or second aspect.

Training the machine learning model may be triggered by one or more of the following conditions: an input, by a user, corresponding to a data sample; a new data sample being available; client device temperature being above or below a threshold; client device power status or availability; client device processor usage above or below a threshold; or presence of data sample on client device.

### BRIEF DESCRIPTION OF THE DRAWINGS

Certain embodiments of the present invention will now be described, by way of example, with reference to the accompanying drawings, in which:

FIG. 1 is a photograph of two people each casting a shadow;

FIG. 2 is a photograph of one person casting a shadow;

FIG. 3 is a photograph of a light source passing through windows and casting shadows;

FIG. 4 is a photograph of a person in front of a window surrounded by curtains;

FIG. 5 are two photographs of a baseball diamond;

FIG. 6 is a photograph of a person casting a shadow on a floor and a predicted shadow mask indicating the region of the shadow;

FIG. 7 is a schematic diagram of mask generation;

FIG. 8 is a schematic diagram of mask generation and shadow removal;

FIG. 9 is a photograph of a person in a car park;

FIG. 10 is a photograph of four cylinders and two light sources;

FIG. 11 is a photograph of two shadows cast on a floor;

FIG. 12 are three photographs with shadows superimposed on them;

FIG. 13 is a schematic diagram of predicted shadow mask generation;

FIG. 14 is a schematic diagram of predicted shadow mask generation after a user input;

FIG. 15 is a synthetic scene including synthetic shadow representations;

FIG. 16 is a schematic diagram of mask generation from a user device;

FIG. 17 is a schematic diagram of mask evaluation;

FIG. 18 is a process flow diagram of the method of generating a predicted mask for a data sample;

FIG. 19A to 19H are photographs with different user input examples overlaid;

FIG. 20 is a schematic flow diagram of a user input being implemented in a mask generation method;

FIG. 21 is a process flow diagram of data sample evaluation;

FIG. 22A to 22D are photographs and masks of a scene and user inputs to a scene;

FIG. 23 is a schematic diagram of predicted mask generation and confidence value generation;

FIG. 24 is a process flow diagram of training candidate selection;

FIG. 25A to 25D are photographs of documents including shadow regions;

FIG. 26A to 26D are photographs of outdoor spaces including shadow regions;

FIG. 27A to 27D are photographs of food including shadow regions;

FIG. 28 is a process flow diagram of a method of obtaining a domain score;

FIG. 29 is a process flow diagram of the method to begin training a model;

FIG. 30 is a system block diagram of a first system for generating an aggregated model weight; and

FIG. 31 is a system block diagram of a second system for generating an aggregated model weight.

### DETAILED DESCRIPTION

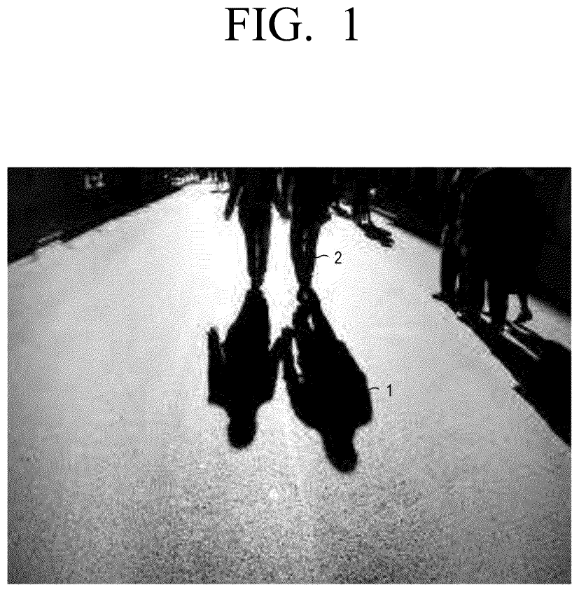

Referring to FIG. 1, a shadow 1 is present whenever a source of light is blocked by a non-transparent object. For example, FIG. 1 is a photograph where the camera is pointing in the direction of the sun with people 2 walking on the road casting a shadow 1 towards the camera which captured the photograph. Dark areas are generated in the photograph where the people are blocking the sun.

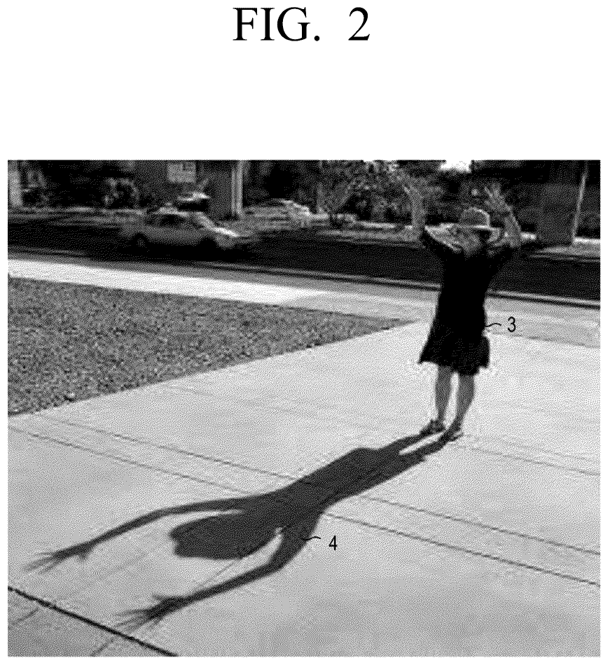

Shadows can indicate the direction of a light source, and possibly the time of day. Referring also to FIG. 2, a photograph of a woman 3 in a straw hat with her arms held up by the side of her head, casting a shadow 4 from back right to front left, indicating that the sun, i.e. the light source, is coming from the back right direction.

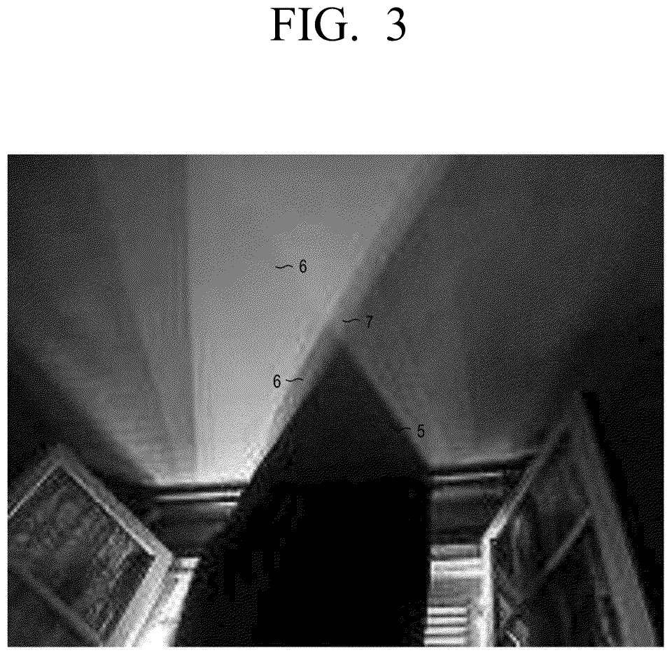

Different light sources generate different types of shadows. For example, light sources may be point light, non-point light, or be from multiple light sources. Referring to FIG. 3, sometimes, complex shadows are generated when the light source passes through multiple openings, or there are multiple sources of light from one or more directions. For example, umbra regions 5, penumbra regions 6 and antumbra regions 7 are present in the photograph in FIG. 3 of a light source passing through a window and some blinds.

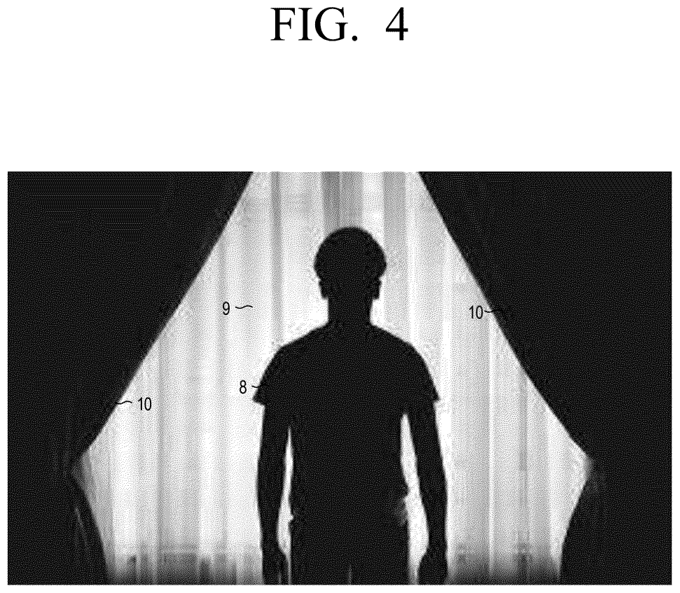

Referring to FIG. 4, shadows can generate degraded visibility, obscuring features which a person may want to view. For example FIG. 4 is a photograph of a person 8 stood in front of a window 9 through which a source of light is emanating. The window is framed by curtains 10. The person 8 and the curtains 10 are blocking light from the light source. It is difficult to determine from the photo whether the person 8 is facing towards or away from the camera which captured the photograph due to shadows obscuring various features.

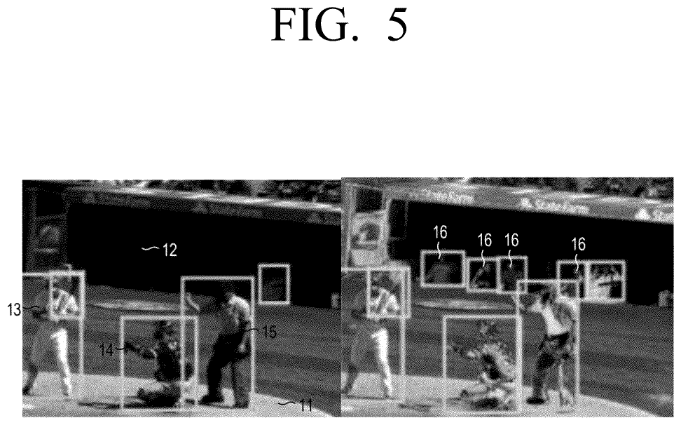

Shadows can also have the effect of obscuring objects in photos, therefore rendering them “missing” when image analysis is performed on the photo. Referring to FIG. 5, on the left hand side, a photograph of a baseball diamond 11 and dugout 12 shows a hitter 13, umpire 14, and catcher 15. The right hand side photo shows the same photo as the left hand side, but with shadows removed, revealing four more people 16 in the dugout 12 who were obscured in the photo on the left hand side. Without shadow detection, the missing people 16 or objects would not be analysed further in any image processing as they were not identified in the image.

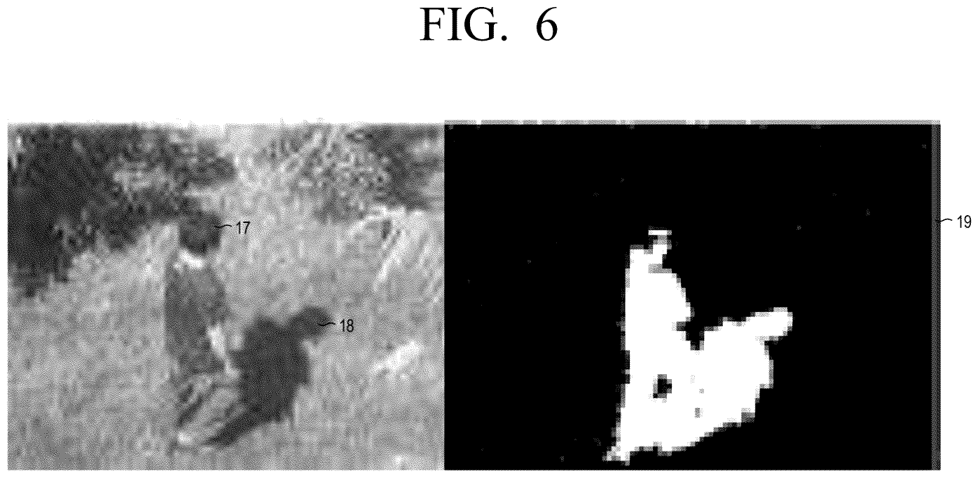

False positives, can also be a problem, for example, shadows can give the impression of an object being present in a photograph. Referring to FIG. 6, on the left hand side is a photo of a person 17 walking in a field casting a shadow 18 from front left to back right. On the right hand side is a binary mask 19 of the person detected by image analysis in white and the background in black. The mask includes the person 17 and his shadow. Depending on the application, the mask may have been intended to identify the person only, for example, fore further image analysis, or the shadow only, for example, for shadow removal.

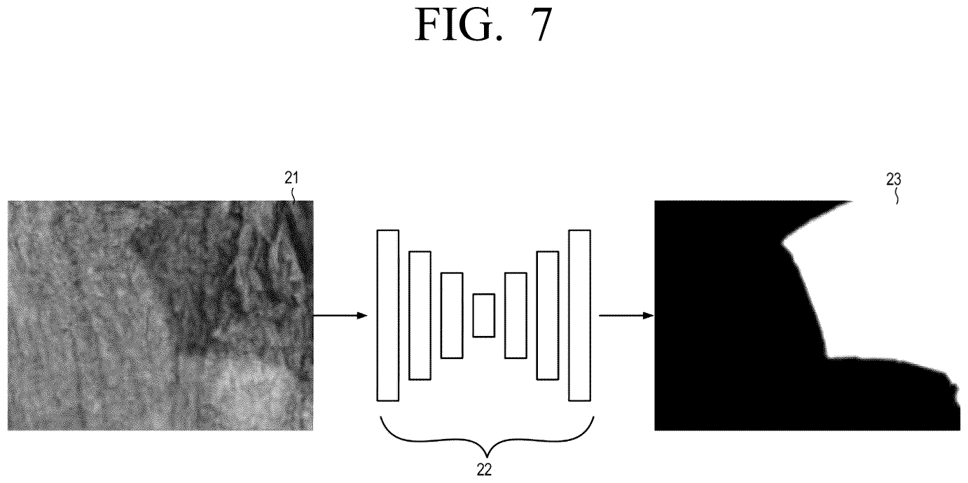

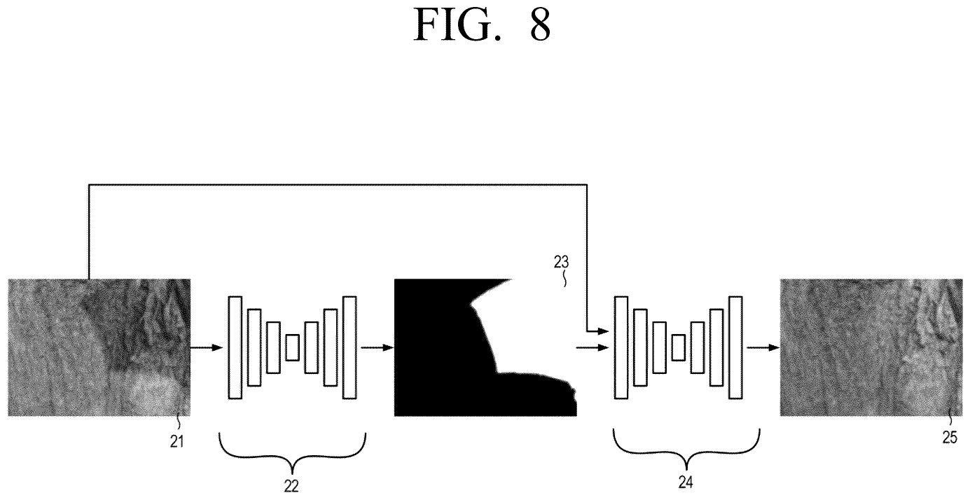

Identifying the location of a shadow in an image allows the removal of the shadow. Further, when coupled with object detection or identification, shadow identification gives strong clues about the number of light sources, and their respective directions in a scene. Referring to FIG. 7, an input image 21 of tree bark with a shadow cast over part of the right hand side of the image is input into a model 22 (for example a shadow detection model), for example, a convolutional neural network, and a shadow mask 23 is output from the shadow detection model 22. Referring also to FIG. 8, the shadow mask 23 is then input into a shadow removal model 24, which may also be a convolutional neural network, and a shadow free image 25 is output from the shadow removal model 24. The model 22 may be any suitable machine learning (ML) model which has been trained on a dataset.

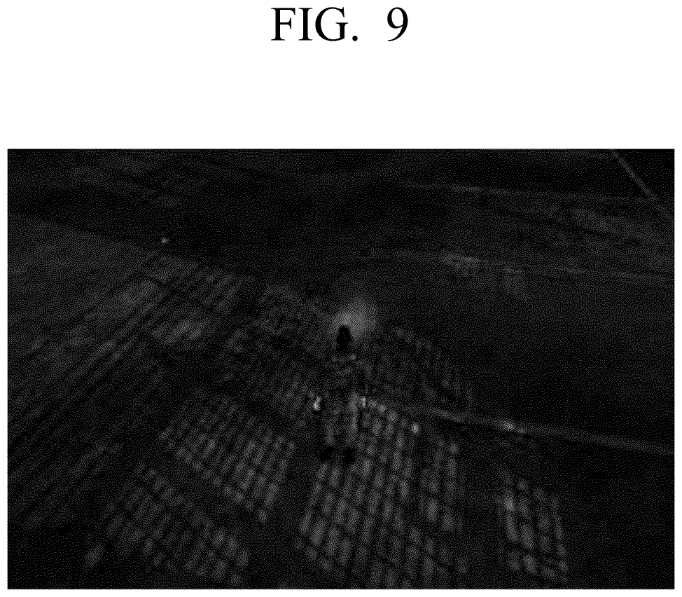

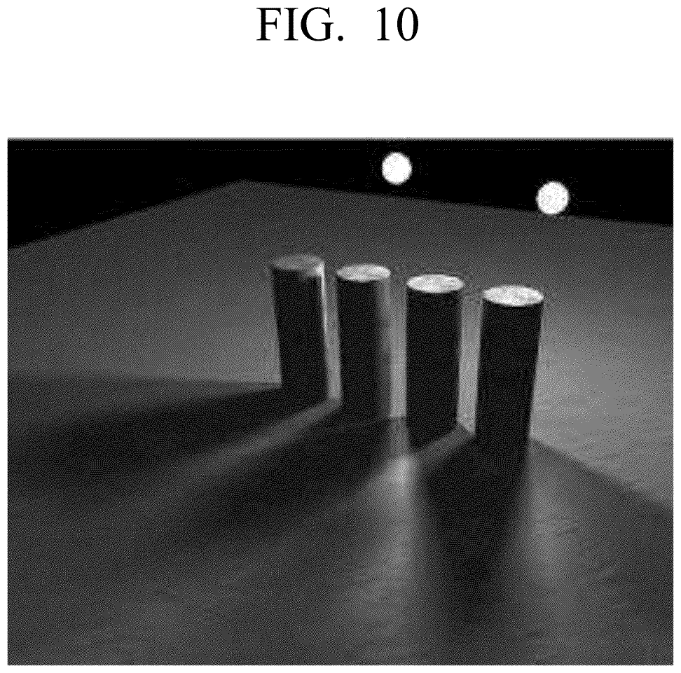

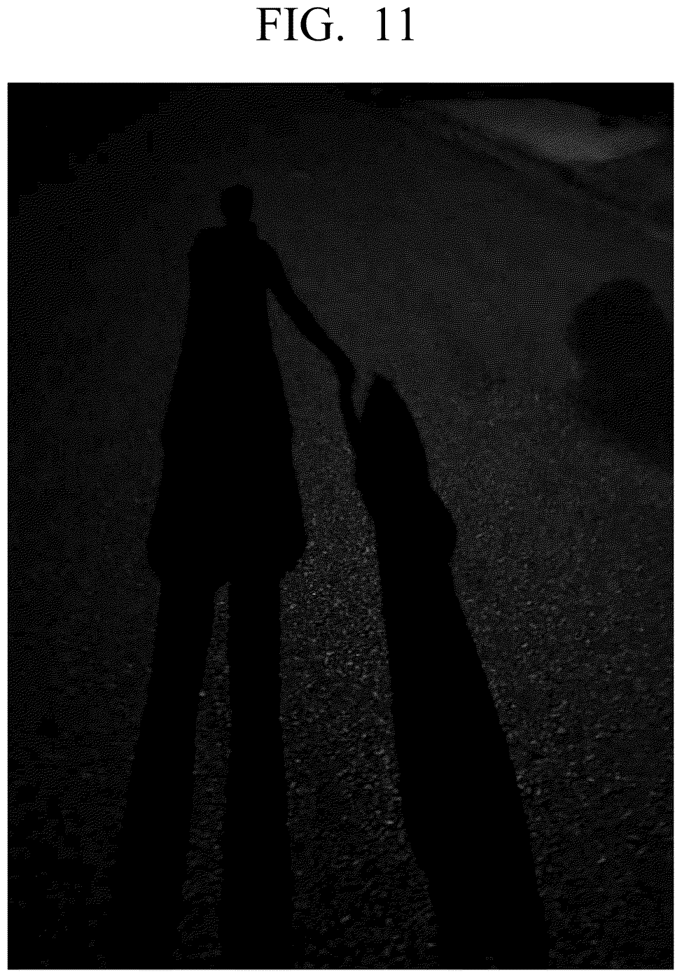

Referring to FIGS. 9 to 11, shadows in multiple situations, scenes, or domains are shown in images or photographs. Referring to FIG. 9, an image of a person in a car park or parking lot shows multiple shadows of varying intensities at different angles, indicating light sources at different intensities (e.g. distances or lumens), and at different angles. Referring to FIG. 10, an indoor scene of four cylinders spaced apart and back lit from first and second light sources having different locations, and therefore providing light from different directions generates a variety of complex and overlapping shadows. Referring to FIG. 11, different colours of light may generate different complex images with various shades projected onto different surfaces, for example, a yellow or orange light is illuminating the photo in FIG. 11. Different coloured light sources can make shadow detection more difficult, especially if the model of shadow detection is only using pixel colour and not geometry information.

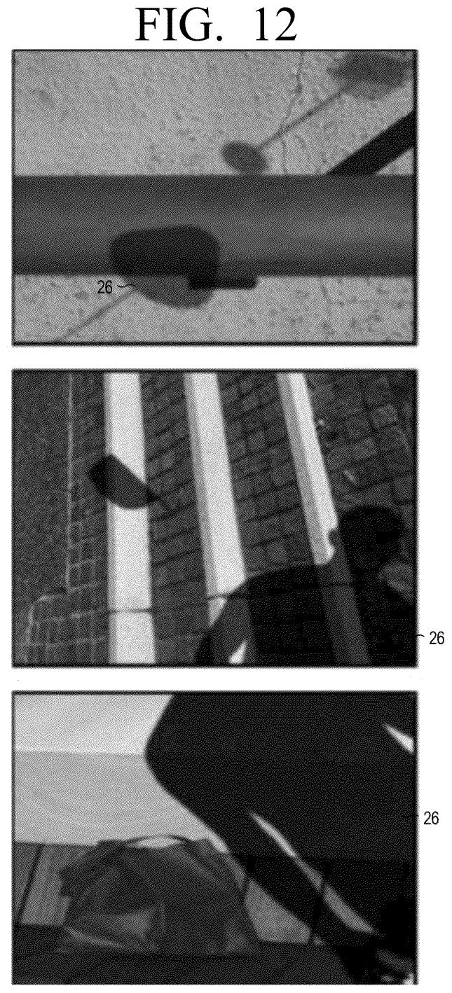

Referring to FIG. 12, three images are shown of different scenes, with a synthetic shadow 26 implemented or superimposed onto the image. While training models on such images can be useful for learning colour information that shadows generate, the models are inherently geometry unaware, and therefore the model cannot account for geometry in a new image.

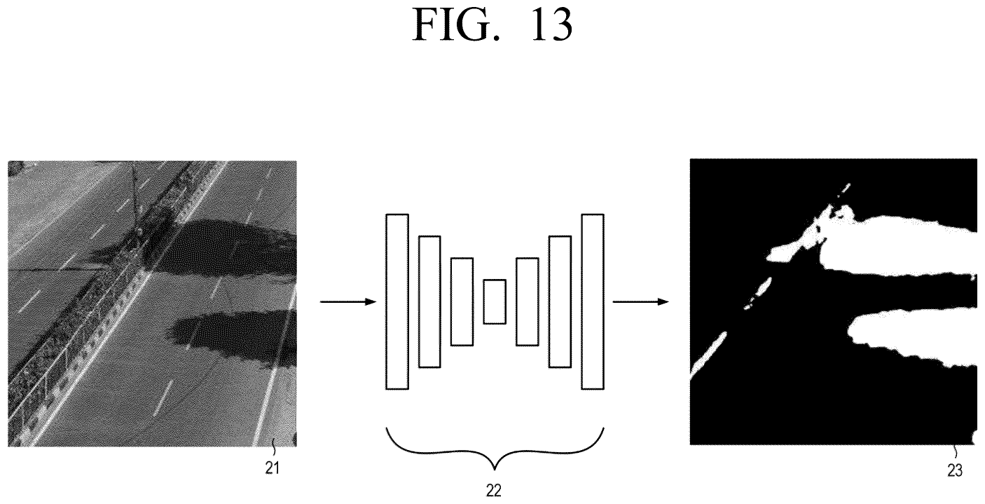

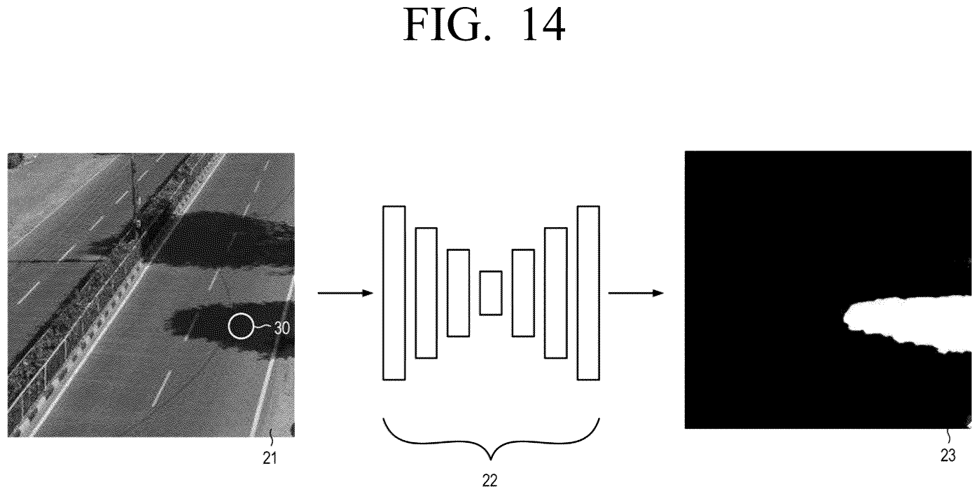

User input can be a valuable tool when preparing a shadow mask for an image. For example, a user may want to eliminate only one shadow from an image, or there may be a subtle difference between a shadow and background which a user can easily identify. Referring to FIG. 13, a shadow mask generation model 22 is applied to an image 21 of a road that has shadows cast over one lane of the road from one tree and over two lanes of the road from another tree. Without user input, all shadows are detected and a shadow mask 23 is generated by the model 22 for all the shadows. Referring to FIG. 14, a user indicates the location 30 of a shadow by an input such as a click or a swipe, or pressing the shadow location on a screen. The user-provided location data 30 is also added to the model and only the user-selected shadow is represented in the shadow mask 23.

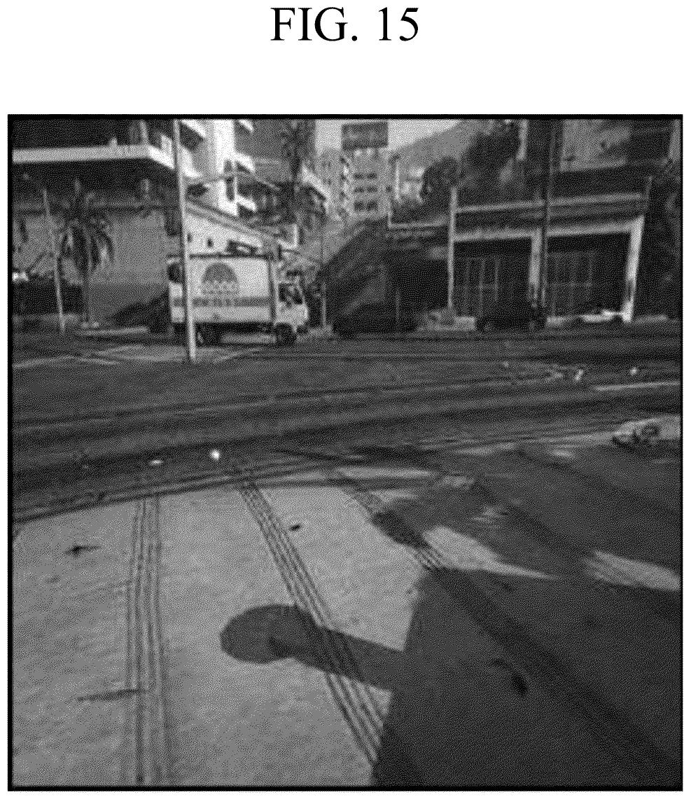

Unlike certain computer vision tasks, there are no on-device sensors that can generate labels for shadow detection training. Depth estimation tasks can use stereo cameras or time of flight (ToF) sensors to generate ground-truth. Image tilt estimation task can use inertia measuring units (IMUs) to generate ground-truth. The ability to generate data or ground-truth pairs on-device unlocks privacy-preserving on-device training, which in turn makes models more accurate and robust to data-shift. One solution is to generate on-device data/ground-truth pairs to achieve generalization. However, synthetically generating data requires domain-adaptation solutions as some shadows would be inappropriate for certain domains. Synthetically superimposing shadows on real images assume shadow-free images, which may be unrealistic for images captured by a user's device, such as a smartphone. For example referring again to FIG. 12, dark shadows have been synthetically generated on real-image, but ground-truths will miss existing shadows. However, user generated data or labels, such as shadow location data, cover all possible scenarios/edge cases, allowing a diverse and robust dataset to be complied. Referring to FIG. 15, a synthetically generated scene from Grand Theft Auto Five (GTA 5) shows a scene of a road in a city with a shadow cast in the foreground from bottom right to the image centre. A domain adaptation solution is required to transfer the knowledge of where the shadow is to the model.

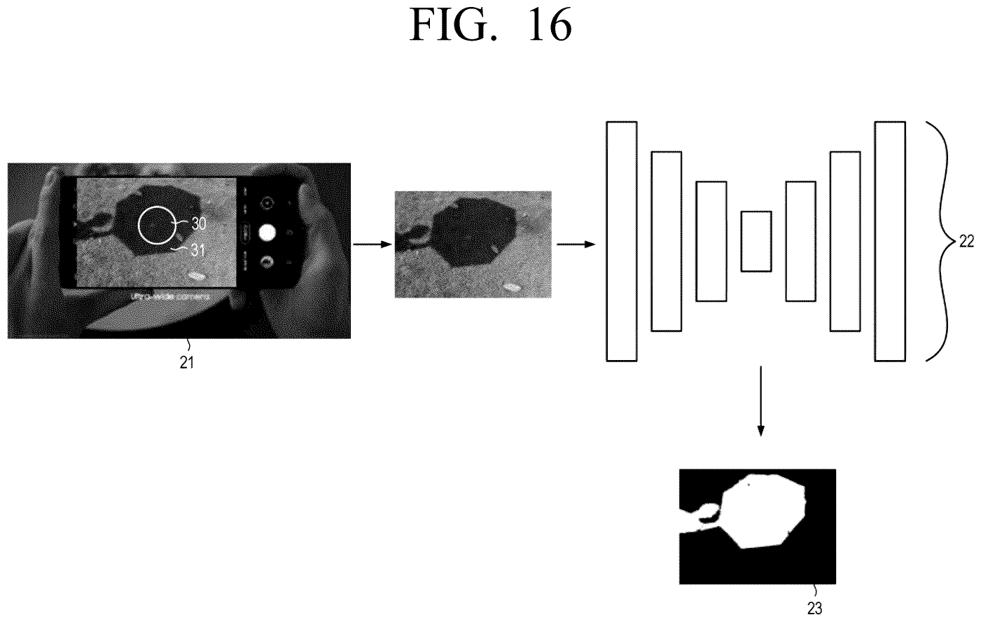

Referring to FIG. 16, a user receives or takes an image 21 with their phone. The user then identifies a location 30 of a shadow 31 in the image 21. The image 21, along with the user-input location information 30, is input to the shadow identification model 22. A shadow mask 23 is generated and output from the model 22. The shadow mask 23 may then be used to label or identify a region of an image onto which a shadow removal model can be applied. The labelling of a shadow by a user allows user-guided detection results, and also allows personalisation as the user can select certain shadows to be removed (such as their own shadow, or a shadow cast by their phone), while keeping other shadows in place. Inputting user-guided detection results into the model may also increase accuracy. This may allow for improved shadow detection, and a more accurate predictive shadow mask 23 being generated.

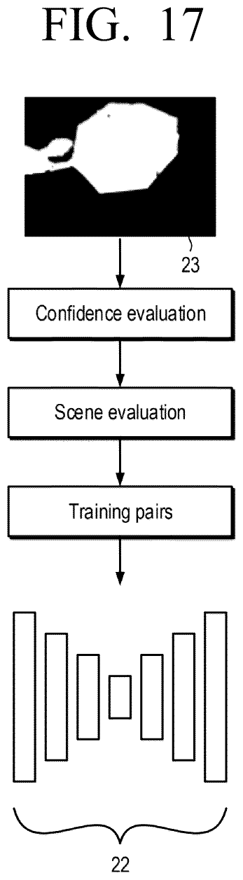

Referring to FIG. 17, the shadow mask 23 may also then be assessed as a potential training candidate pair (that is, the mask 23 together with the input image 21, also referred to simply as “data sample”) for training a model 22. As will be explained in more detail later, the confidence that the shadow mask is accurate may be evaluated by performing cross-entropy confidence evaluation to find informative samples. Again, as will be explained in more detail later, the scene or domain of the image is then determined based on certain attributes. For example, certain attributes of the image may indicate that the image is a photo taken indoors with a shadow from one particular direction, or outdoors at night with multiple sources of light from different directions. If the scene evaluation reveals that the data sample and mask pair (e.g. image 21 and shadow mask 23) are underrepresented in the dataset used to train the model 22, they may be added to the dataset ready for the next training round. Thus, a light-weight efficient network model 22 may be generated which is capable of working in real-time.

While the problems and methods so far have been described in relation to identifying the location of shadows in images, and their removal from an image, the methods described herein can also be applied to other types of data, for example, sensor data such as temperature, movement, location and the like which may indicate the status of devices or structures indicating vital safety information.

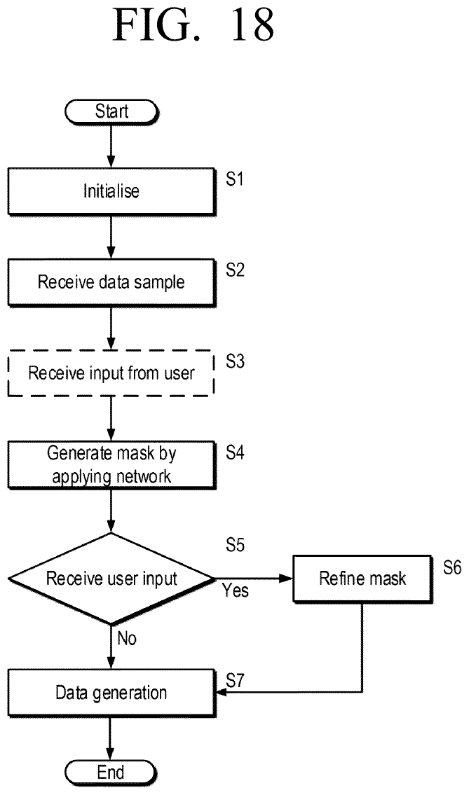

Referring to FIG. 18, the method is initialised (step S1) and a data sample is received (step S2). The data sample may be for example, a digital image 21 including a region which indicates a shadow 31. Optionally, the method may comprise receiving an input provided by a user (step S3), for example the location 30 of the region indicating a shadow in the digital image 21. A mask (e.g. a shadow mask 23) may be generated from the input data sample and, optionally, the input provided by a user (step S4) by applying a network to the data sample. The network may be a machine learning model, for example a convolutional neural network. The mask may be, for example, a binary indication of the location of the region of the image indicating a shadow is present. Optionally, a further input may be provided by the user (step S5). The further input may indicate that a refinement of the mask is required. For example, an input image 21 may be presented to a user with the generated mask 23 overlaid. A user may then be able to refine where the mask indicates the location of the shadow by selecting or deselecting certain locations, or increasing or decreasing certain attributes of the data sample or image 21. Using the optional user input, the mask may be refined (step S6), for example by adding or removing regions of an image which may represent a shadow being cast. As will be explained in more detail later, the data sample (e.g. image 21) and the mask (e.g. shadow mask 23) may then be considered as candidates to be added to a dataset used to train a machine learning model to identify masks (step S7).

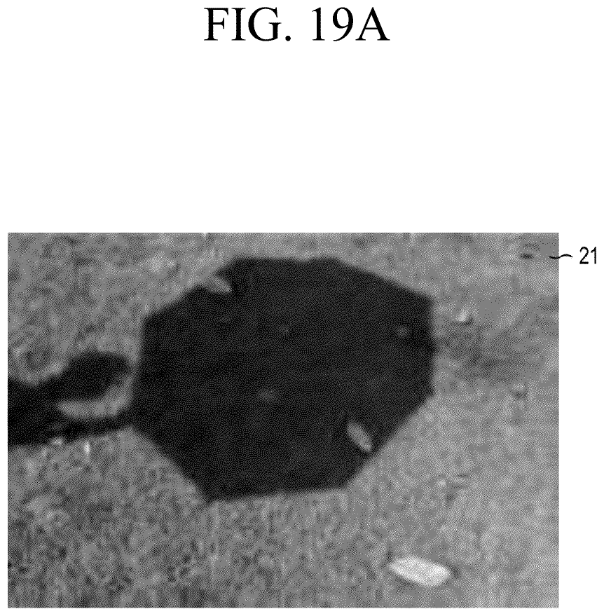

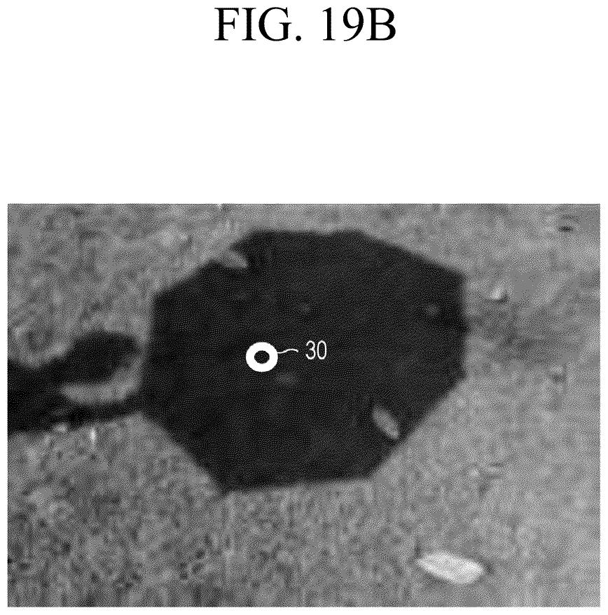

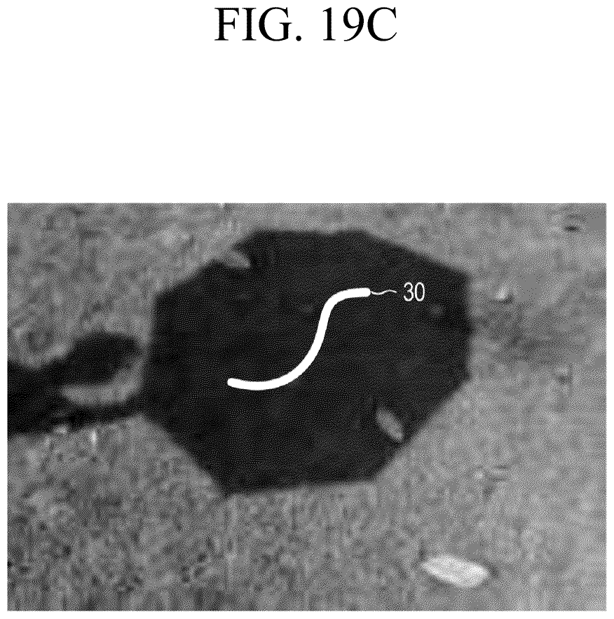

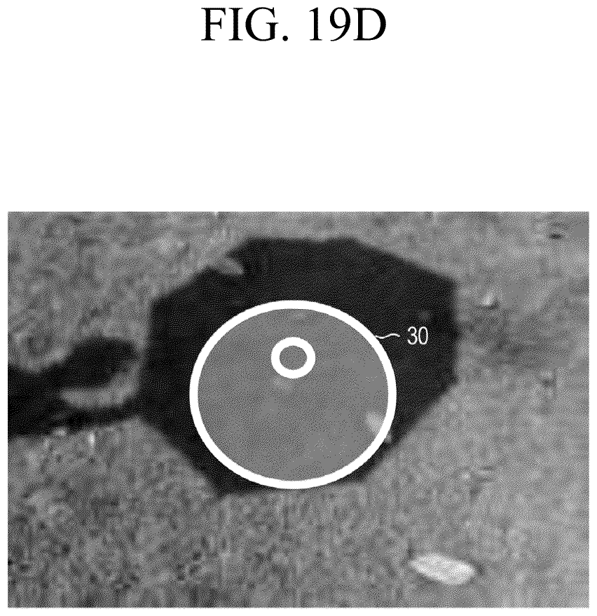

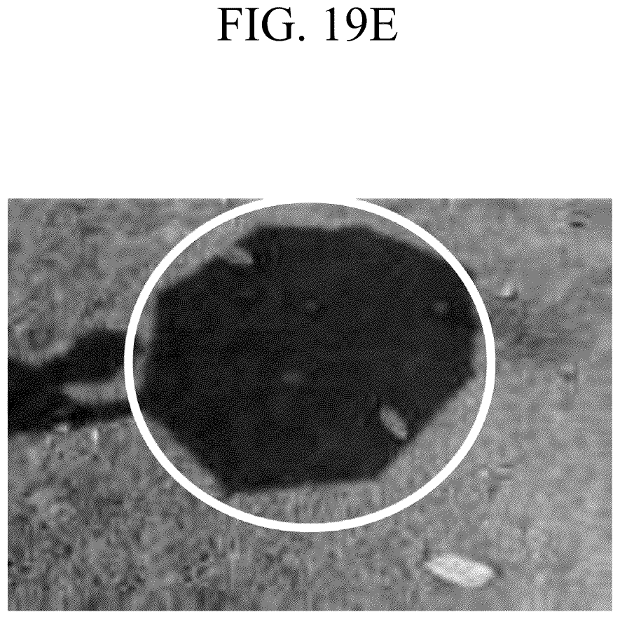

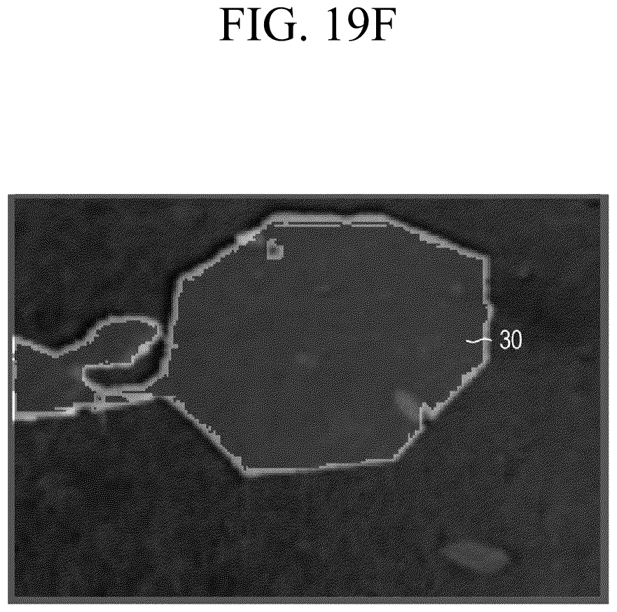

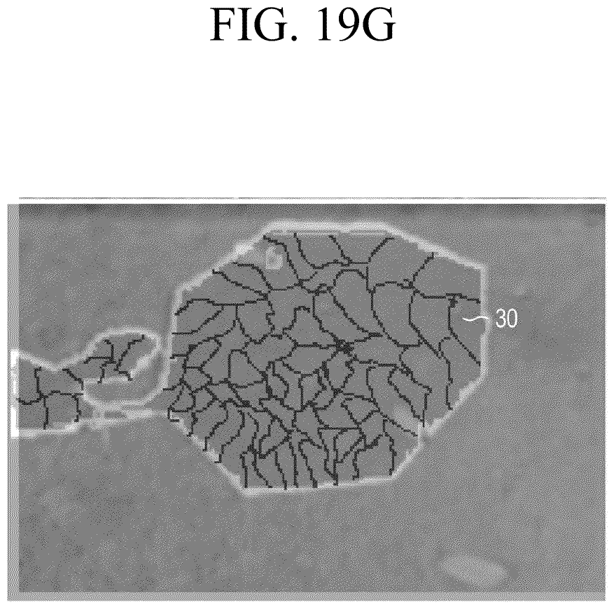

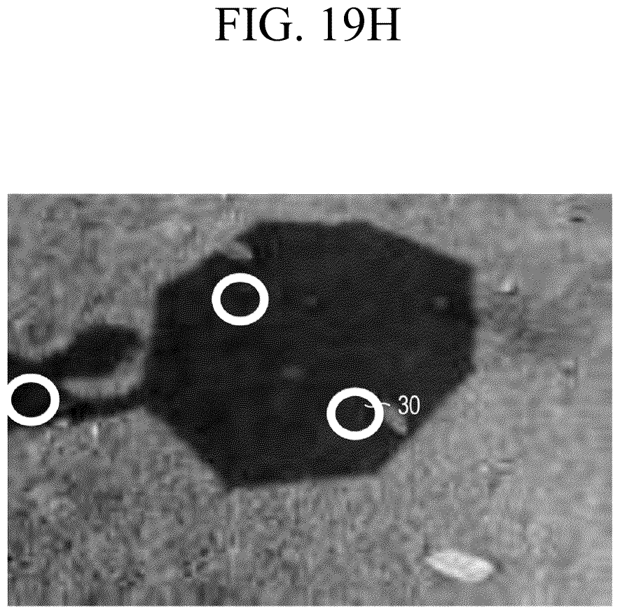

Referring to FIGS. 19A to 19H, user inputs may be applied to an image in a variety of ways. Referring to FIG. 19A, an example input image 21 is a photograph of a playing field with a shadow of an umbrella cast over the grass of the playing field. FIGS. 19B to 19H show different ways a user can provide an input 30 to the image 21 to indicate the presence of a region in the image indicating a shadow. FIG. 19B shows an example of a user click to identify the centre of the shadow. FIG. 19C shows a user stroke over the pixels indicating the location of the shadow. FIG. 19D shows an example of a user-driven blob detection. FIG. 19E shows an example of a user providing a drawing around the region of the image 21 indicating a shadow. FIG. 19F shows an example of a user-click colour segmentation approach. FIG. 19G shows an example of user-click super-pixels used to identify the region representing a shadow in the image 21. FIG. 19H shows multiple user clicks which have been used to identify different parts of the region shadow representing a shadow.

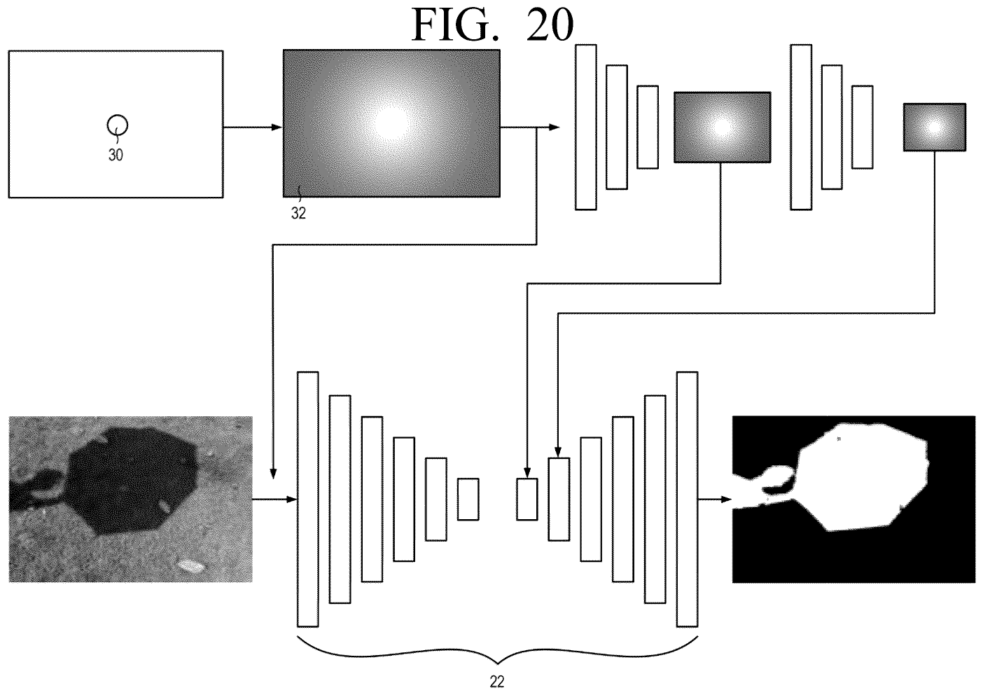

Referring to FIG. 20, the lightweight network model 21 can accommodate user inputs in any form, or no user input, for example, one of the user-inputs shown in FIGS. 19A to 19H. If a user input is received, the input may be processed to convert it into a user-input mask 32. The user-input mask 32 may be represented by a Gaussian, Euclidian, Cosine or any other (e.g. distance) map. The user-input mask 32 may be integrated into multiple layers of the (decoder) network model 20, by down-sampling when necessary. Down-sampling may be performed as many times as is required. Down-sampling can be fixed or learned end-to-end. When training the network model, user-inputs (positive and negative inputs, representing the presence and absence of a region representing a shadow), are integrated into the network and then the network is trained end-to-end.

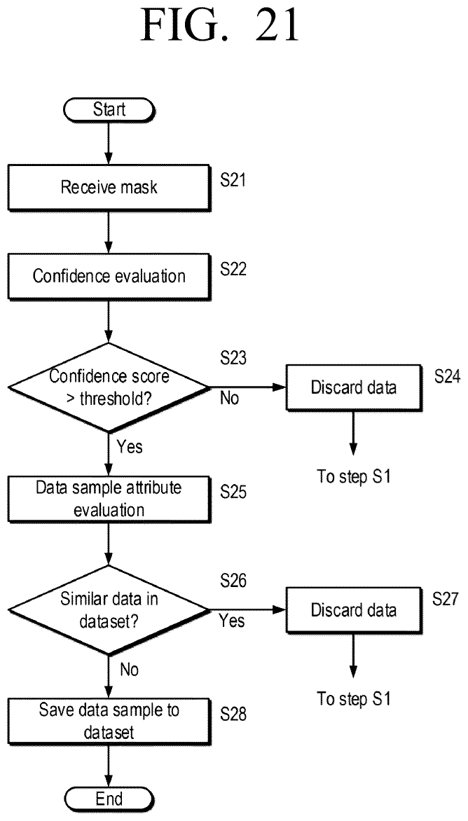

Referring to FIG. 21, once a mask is received (step S21), a confidence evaluation is performed (step S22). The confidence evaluation will be explained in more detail later, but may include calculating the softmax probabilities of each pixel of the data sample/mask pair (step S23). If the confidence evaluation results in a score which is below a threshold (for example a predetermined threshold, or a threshold which is calculated on the fly), the data is discarded as a potential training candidate pair (step S24). If the confidence score is above the threshold, the data sample/mask pair is evaluated to assess its similarity to the data sample/mask pairs represented in the dataset used to train the model 22 (step S26). If the data sample/mask pair is similar to those already represented in the dataset then the data sample/mask pair is discarded (step S27). If the data sample/mask pair is different to those in the dataset, then the pair is saved to the dataset ready for the next training instance.

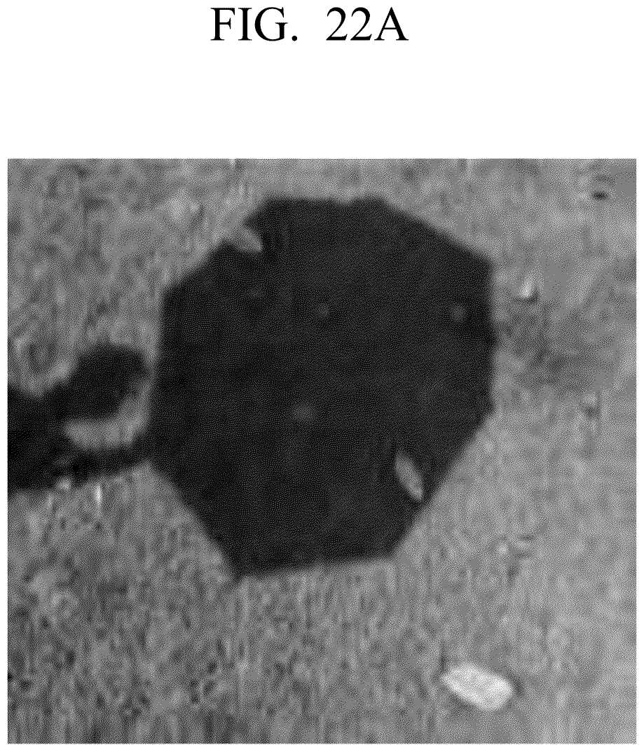

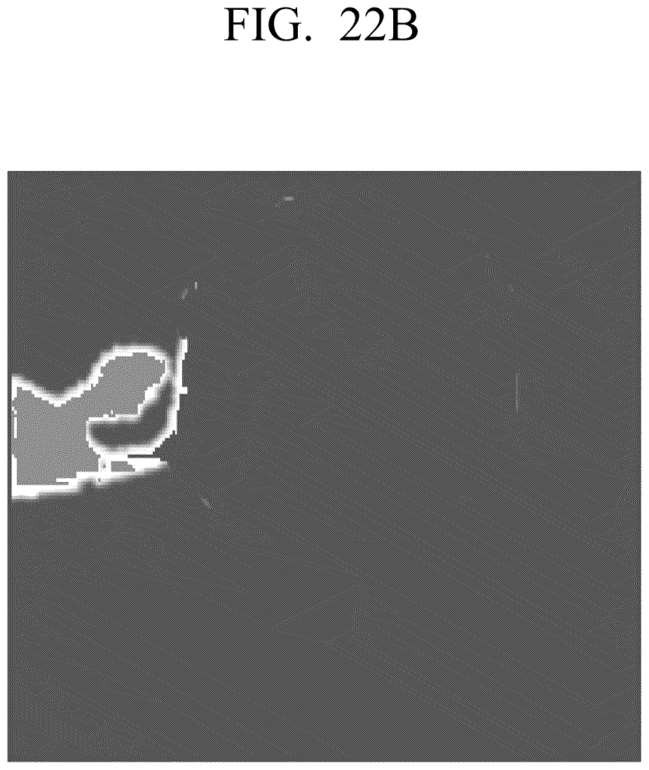

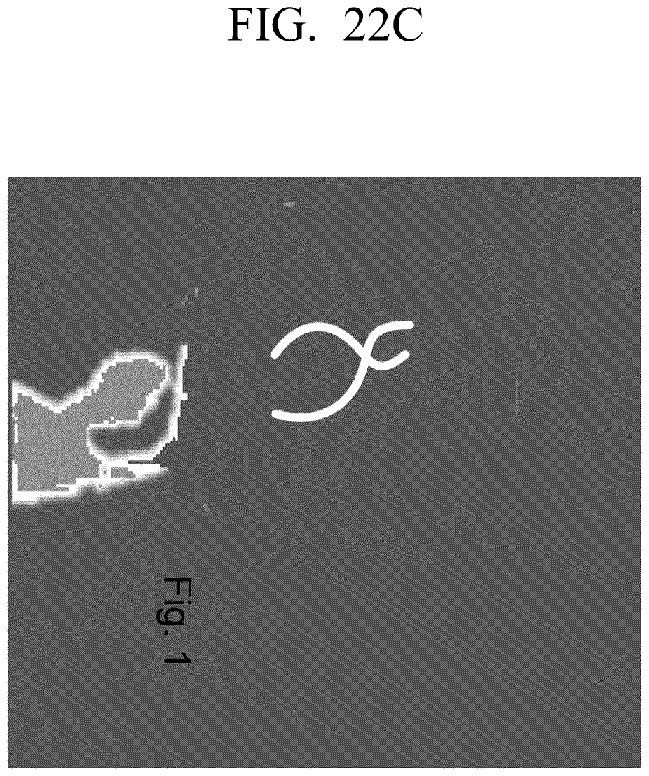

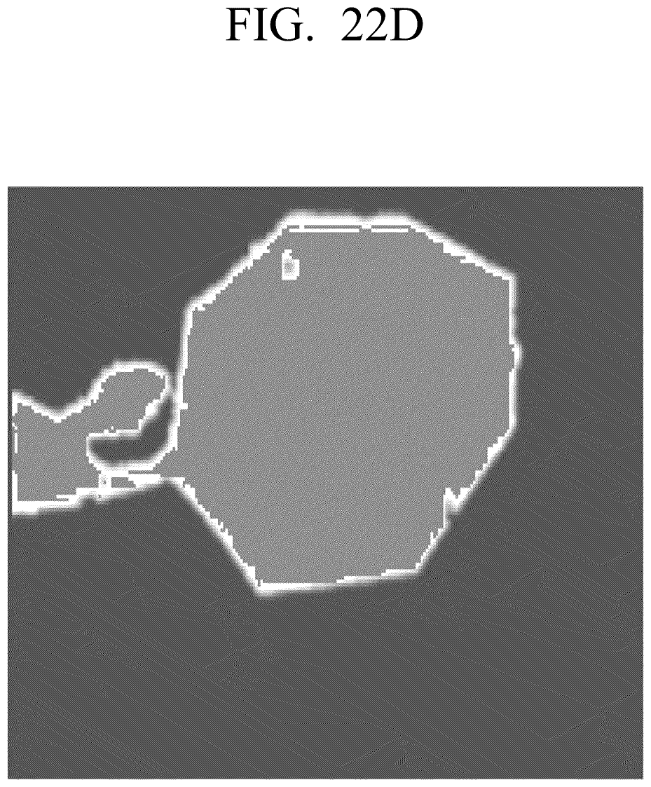

Referring to FIGS. 22A to 22D, users may optionally refine a mask 23 after an initial predicted mask 23 has been generated. For example, a user may be presented with a data sample, e.g. an image 21 (see FIG. 22A), with a mask 23, e.g. a shadow mask, overlaid (see FIG. 22B). The mask may be incorrect in some way, either by being incomplete, or identifying regions of the data sample which should not be covered. Referring in particular to FIG. 22C, a user may provide an input to identify a region which has been missed or identified in error. Referring in particular to FIG. 2D, the additional user input may then also be input into the model 22 to identify the mask 23, which outputs an updated mask 23.

Confidence Evaluation

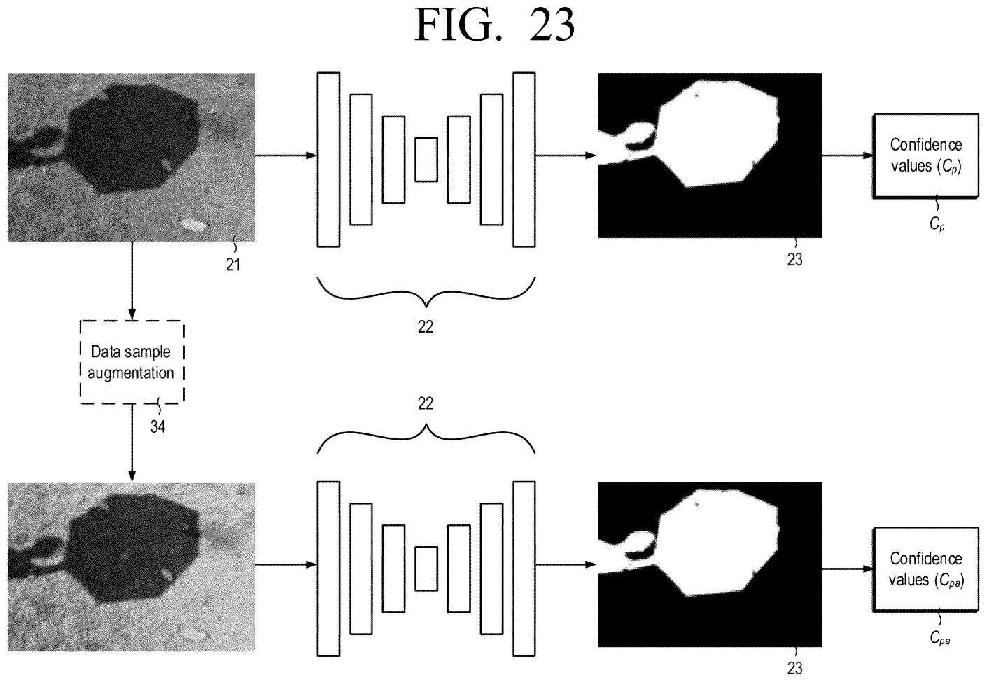

Referring to FIG. 23, the quality of the mask 23 is assessed using a confidence evaluation. For example, the pair of data sample and mask are assessed to see how accurate the mask is at identifying the region of interest (e.g. region representing a shadow) in the data sample (e.g. image). The confidence evaluation may generate confidence values Cₚ which may be averaged into a confidence score. For example, for an image 21 and shadow mask 23 pair, the confidence score may be calculated by performing a pixel-wise prediction, therefore making it possible to obtain the softmax probabilities of each pixel. Optionally, the data sample may be augmented, for example, using an augmentation function 34 from a suitable augmentation library or dictionary. In the case of images 21 having regions representing shadows, the augmentation may not change the location (geometry) of the shadow in the image, otherwise the model 22 will not learn the geometry of how shadows appear in images. The augmented data sample may then also be used to generate a predicted mask 23, and the confidence of this mask may also be evaluated generating augmented confidence valise Cₚₐ, and, if required, then a confidence score.

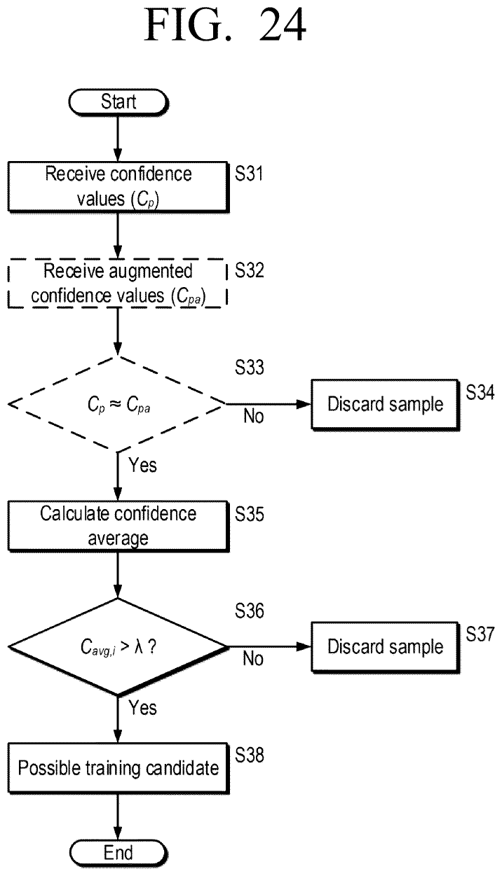

Referring to FIG. 24, the confidence values Cₚ (step S31) and, optionally, the augmented confidence values Cₚₐ are received (step S32). If augmented confidence values Cₚₐ have been received, the confidence values Ci and the augmented confidence values Cₚₐ are compared (step S33). If the two confidence values are not equivalent, the data sample and predicted mask pair are discarded (step S34). If the confidence values are equivalent, an average of the confidence value is calculated. One possible way of calculating the average confidence value (confidence score) is using the formula:

C_{avg,i}=1/PᵢΣₚ₌₀^{P}^{ᵢ}Cₚ (1)

Where Pᵢ is the number of confidence values Cₚ. If the average probabilities C_{avg,i} (confidence) across pixels (or other information from a sensor) of the data sample are below a threshold 2 (step S36), the data sample and mask prediction are discarded (step S37). If C_{avg,i} is above a threshold λ, the data sample and mask pair are possible candidates for training pairs.

Scene Evaluation

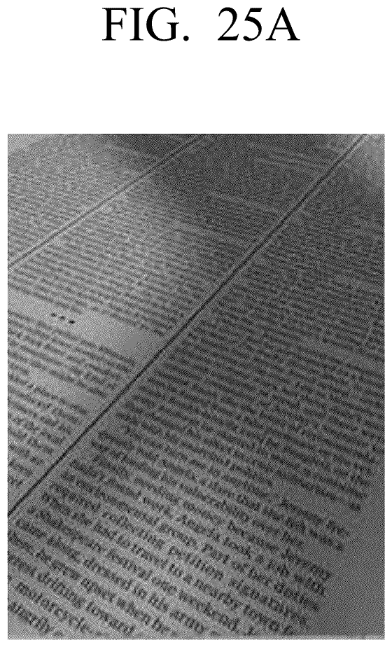

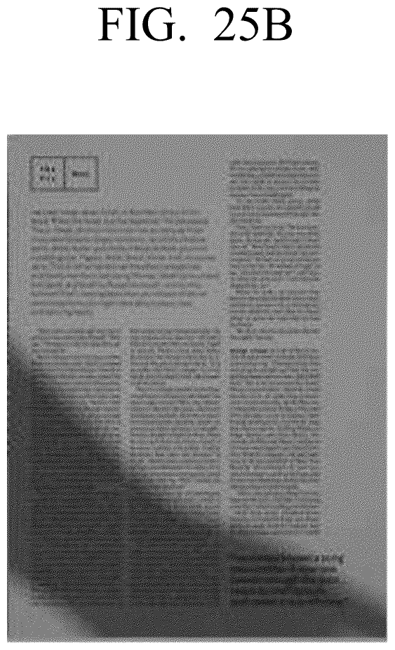

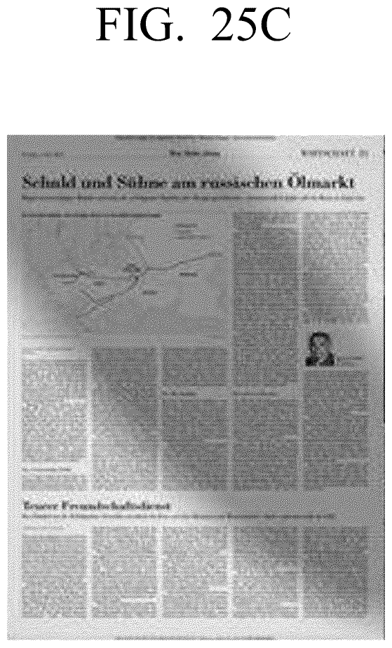

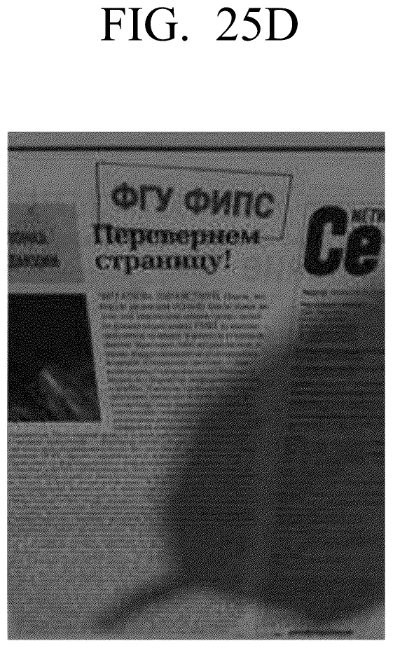

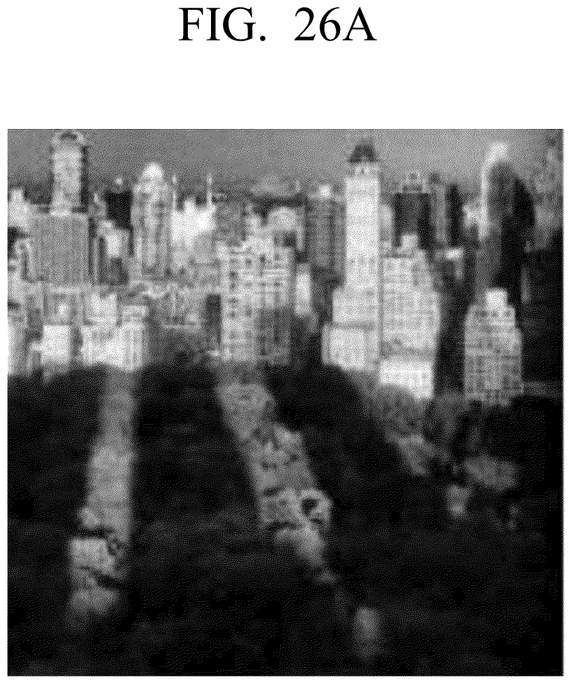

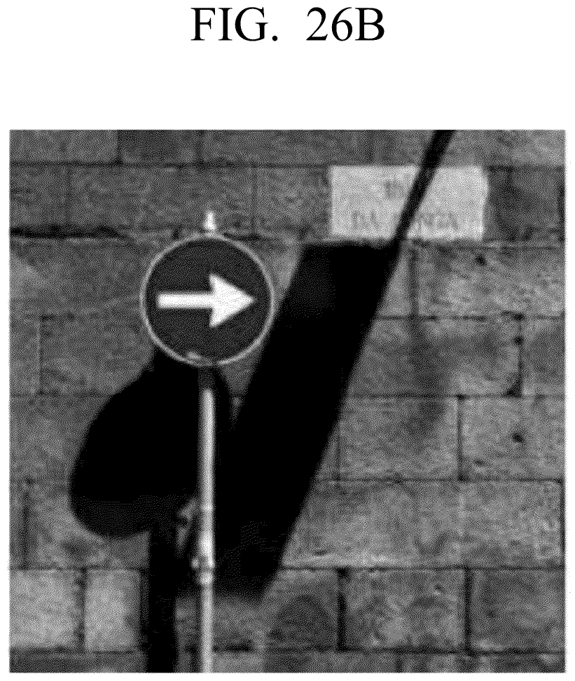

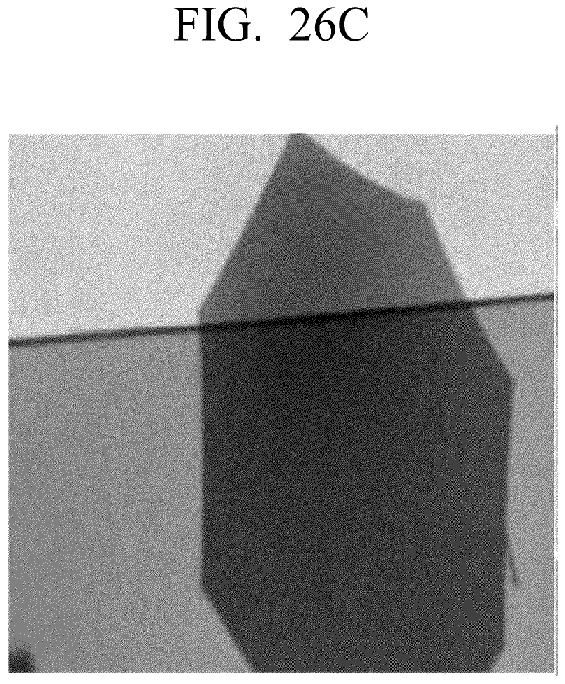

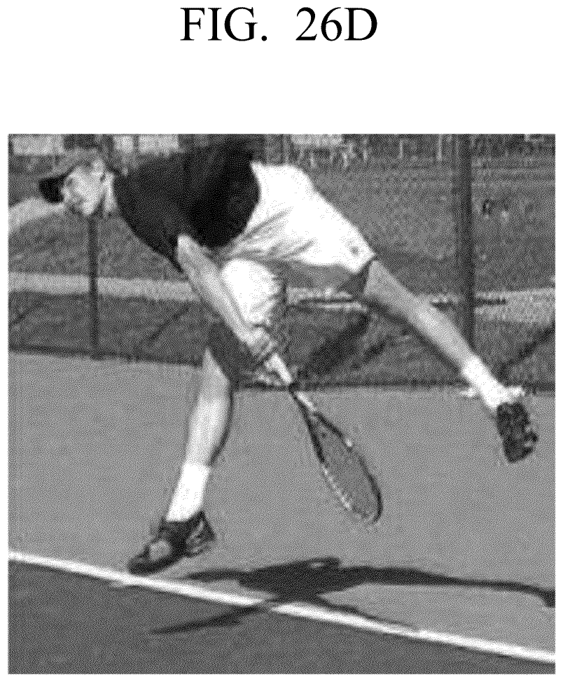

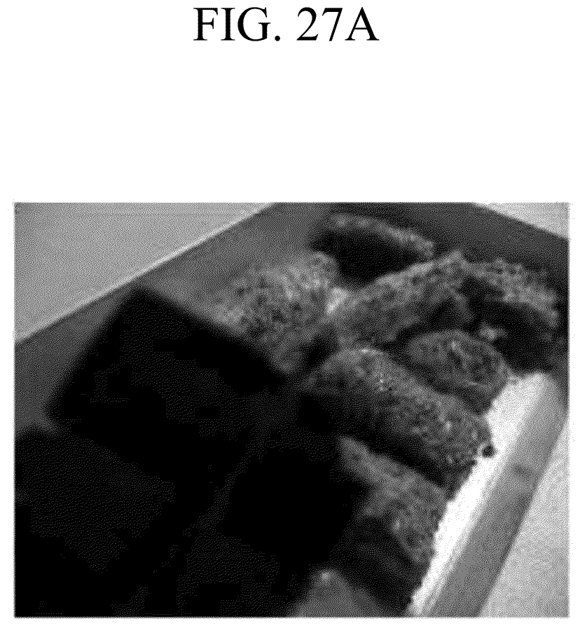

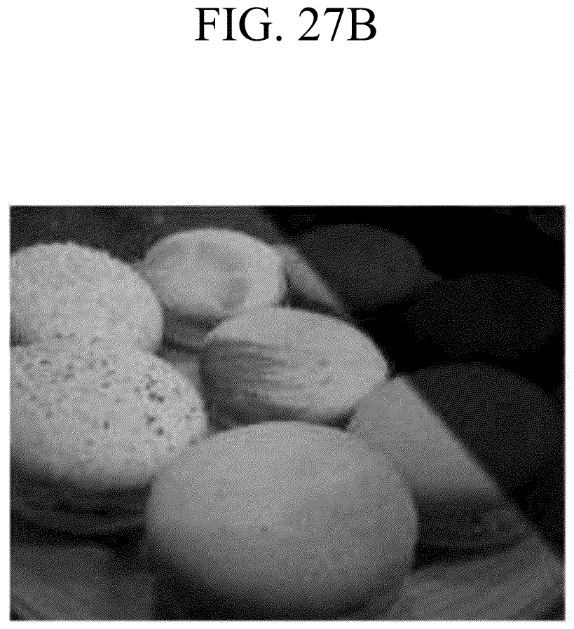

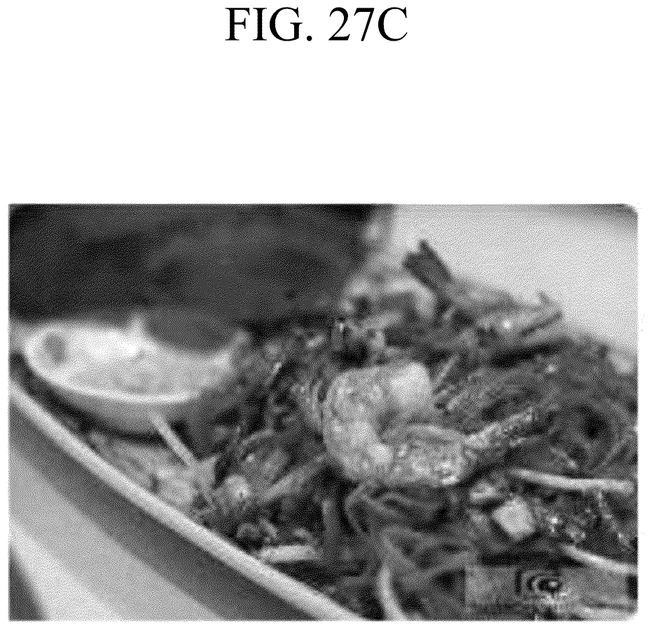

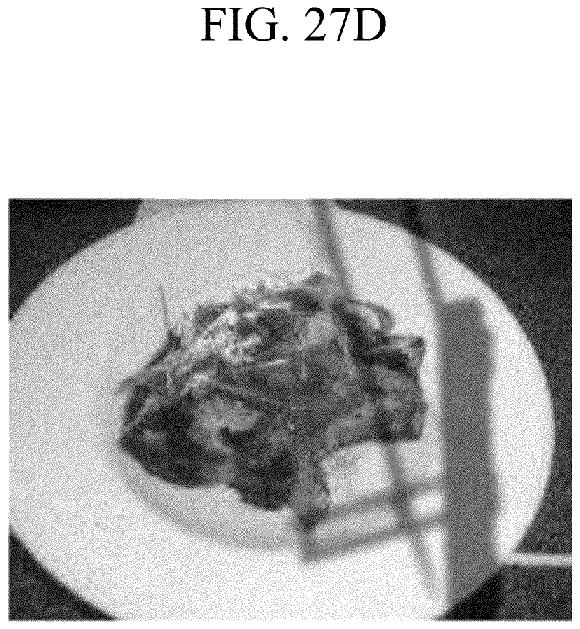

For certain types of data samples, there are a variety of domains that the data sample can occupy. For example, for images 21 having a region representing a shadow, there are variety of scenarios in which shadow detection can be used. Referring to FIGS. 25A to 25D, photographs of documents from different angles and distances can be seen with different shapes, sizes and intensities of shadows covering the text. Referring to FIGS. 26A to 26D, photographs of outdoor spaces present a wide variety of shadow types, again with different angels, intensities, shapes and sizes. Referring to FIGS. 27A to 27D, photographs of food in various settings also show different shadows covering different regions of the images. Due to potential scenarios each of which is associated with a different domain, it is desirable to obtain a diverse dataset for use when training a model 22. The diversity and distribution of the training pairs (data sample and respective mask) can be controlled via scene evaluation and understanding.

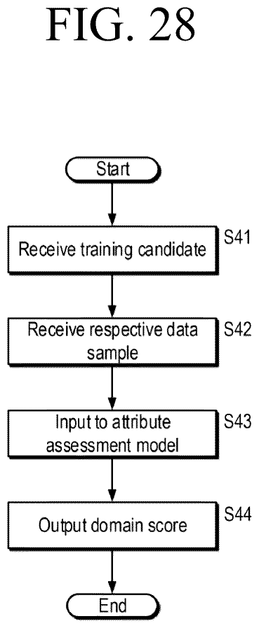

A domain or scene understanding model is used to assess the domain that a data sample occupies, and classify the data sample as being from one or more domains in a client. For example, an image 21 of an outdoor space would be input to a scene understanding model and a score indicating that it is a photograph of an outdoor space would be returned. Referring to FIG. 28, in one example, a training candidate mask 23 is received (step S41), together with the data sample (step S42). These are then input into a suitable attribute assessment model (step S44) which will determine the domain that these candidates belong to, which will then be output (step S44). Possible outputs of the attribute assessment model include feature representations, for example an embedding vector such as a Dᵢ-dimensional embedding vector (i.e. the penultimate layer of the network) extracted from the model, or the softmax probabilities, for example, as a Kᵢ-dimensional vector for the i^{th} client. For example, if the output of the network is a vector of softmax probabilities (for example, a Kᵢ-dimensional vector of softmax probabilities), this can be used as the scene score for the i^{th} client.

The softmax probabilities may be generated (e.g. calculated pixelwise) using the equation:

$${σ ( {x}_{i} )}_{k} = \frac{{e}^{{x}_{k}}}{{\sum }_{j = 1}^{{K}_{i}} {e}^{{x}_{j}}} \qquad ( 2 )$$

for k=1, 2, . . . , Kᵢ and xᵢ=(x₁, x₂, . . . , x_{K}_{ᵢ}) at the i^{th} client.

Dataset Check

To save space in a database containing the dataset and also to achieve a diverse dataset to train a model with, the diversity of the dataset can be evaluated, e.g. by averaging the scene scores from the data samples which are present in the data set. Other metrics can also be used to provide an evaluation of the diversity of the dataset, for example, standard deviation, variance, mode, median and other descriptive statistics, which may be weighted accordingly. If a new data sample/training pair has been identified as a training candidate, the training pair's scene score can be compared to one or more diversity metrics from the dataset. If the comparison yields a result that indicated that the training pair would increase diversity of the dataset, the training pair is added to the dataset, otherwise, the training pair is discarded. For example, if the training pair are images 21 and shadow masks 23, metrics can be chosen as follows; image embedding vectors (are images similar?); shadow locations (are the shadows at the same place?); scene scores (do we have desired scenes in the batch?). Other metrics may be used. Such a method can also save space in the dataset.

In one example, three metrics may be computed for each incoming data sample/training pair. A fast search of the dataset can be performed to see if there is a similar data sample with same metrics already in the dataset. If the new data sample/training pair is similar in most metrics (e.g. 2 out of 3), the data sample/training pair is discarded. If the data sample/training pair is not similar to anything in dataset, the data sample/training pair is saved to the data set. Using discriminative metrics allows the saving of space and facilitates fast searching in the database for similar data. For example, two different training pairs are unlikely to have the same three metrics.

If the comparison of scene scores reveals that the incoming data sample/training pair is a suitable candidate, but that there is currently not enough space in the database to save the new data sample/training pair to the dataset, then a low priority sample may be removed from the dataset, and the new, higher-priority sample saved.

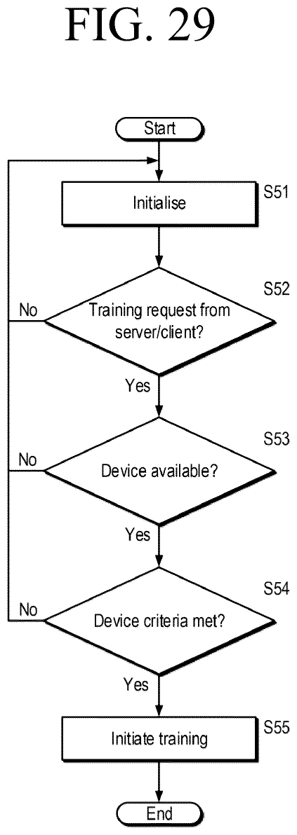

Referring to FIG. 29, training the model 22 may take place when certain conditions are met. For example, after initialisation (step S51), a check is performed (step S52) to ascertain whether a training request has been received from a server or a client. If not, the process goes back to step S51. If the request has been received, a check is performed to determine whether a device is available for training (step S53). If not, the process returns to step S51, if a device is available for training, the status of the device is assessed to determine whether the device is ready for training. Assessing the device criteria can involve determining the status of various parameters on the device, for example, whether the device temperature is within acceptable limits, whether the device connected to a main power supply or is charging (e.g. if the device is a smartphone), what the central processing unit or the graphics processing unit usage is (e.g. if low, the training can start, but if the device is performing other tasks, then training waits). Finally, a check as to whether there is an appropriate dataset on the device is performed. If these conditions are satisfactory, then training can start.

Diversity-Aware Federated Learning

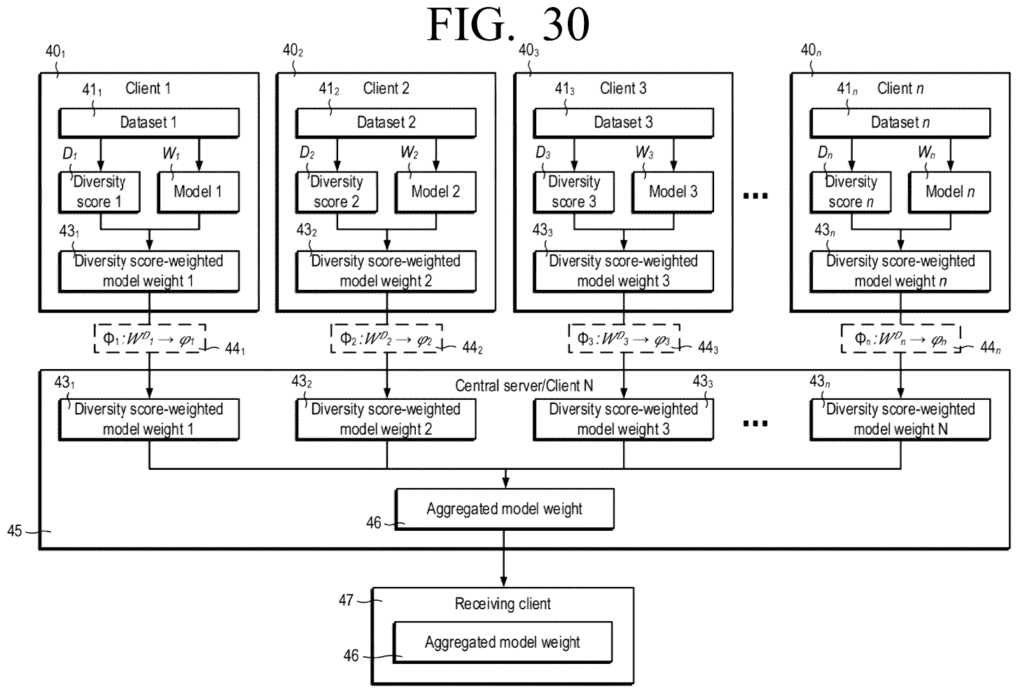

Referring to FIG. 30, a client 40, such as a smart phone or tablet, includes a dataset 41, a model weight W, a model diversity score D. Using these two parameters, a diversity score-weighted model weight (W^{D}ₙ) 43 is calculated on the client by applying the diversity score to the model weight. Thus, the model weight now takes into account the diversity of the dataset. For example, if the dataset mainly contains images of a particular domain type (e.g. lots of photos of food), it would have a low weight, whereas if the dataset was a diverse dataset (e.g. photos from a wide variety of settings), it would have a high weight. There may be a number n of clients 40. As described above, the diversity score may be determined from the dataset. The model weight W may be determined either by training the model on the dataset to obtain a model weight, or by receiving a model weight from another client or a central server.

Optionally, a differential privacy function may be applied to the diversity score-weighted model weight 43, for example, using the following equation:

ϕᵢ:W^{D}^{ᵢ}→φᵢ (3)

Thereby generating a privatised weight 44 φᵢ which may be shared among n clients and servers instead of model parameters, thus, maintaining privacy of user information or data.

Each of the n clients' diversity score-weighted model weights 43, or the privatised weight 44, are sent to a single of the n clients, a different client, or to a central server 45. After collecting all the diversity score-weighted model weights 43, the weights are aggregated, generating an aggregated weight W_{agg} 46. The weighting scheme can be used with any base aggregation method (i.e. FedAvg, etc.). Assuming simple averaging as the base aggregation method, W_{agg} may be calculated as follows:

$${W}_{agg} = \frac{1}{n} {\sum }_{i = 1}^{n} {φ}_{i} \qquad ( 4 )$$

This aggregated weight may then be sent to a receiving client 47. The receiving client 44 may be one of the n clients. Thus, the aggregated model W_{agg} weight now accounts for the diversity of the data in all of the n clients' datasets, so may not be overtrained on data from one particular domain.

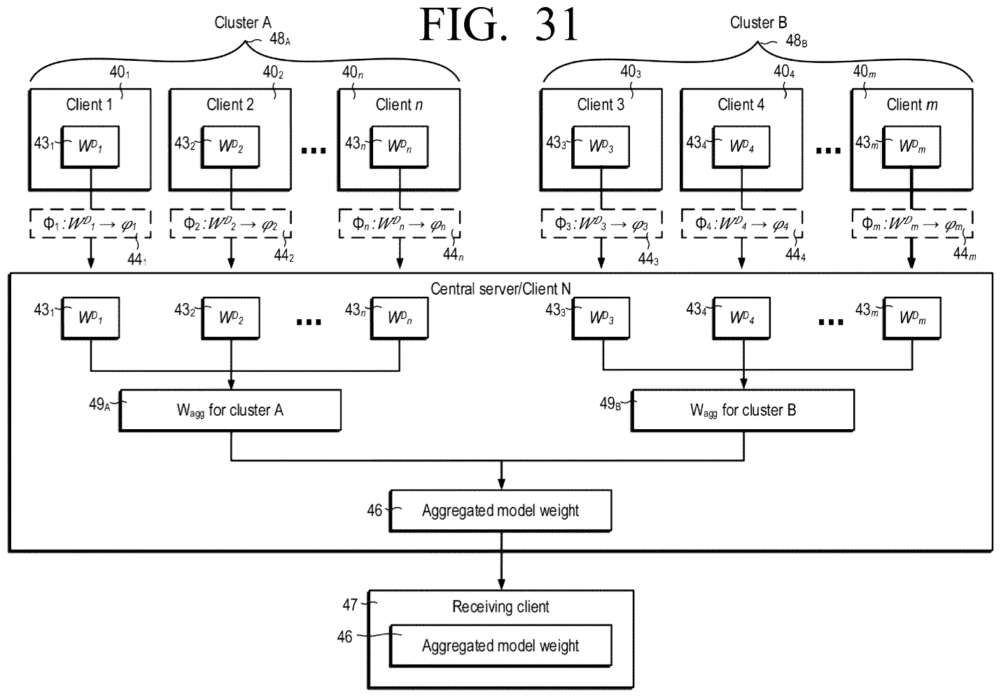

Referring to FIG. 31, clients 40 may be assigned a cluster 48, for example cluster A and B. Cluster A 48_{A} includes clients 40 {1, 2, . . . , n} and cluster B 48_{A} includes clients 40 {3, 4, . . . , m}. There may be any number of clusters, which each may include any number of clients. As in FIG. 30, each client 40 includes a dataset 41, a model weight W, a model diversity score D. Again, using these two parameters, a diversity score-weighted model weight (W^{D}ₙW^{D}ₘ) 43 is calculated on the client 40 by applying the diversity score to the model weight. Optionally, a differential privacy function may be applied to the diversity score-weighted model weight 43, thereby generating a privatised weight 44 φᵢ. The diversity score-weighted model weights 43 or the privatised weight 44 are then sent to the central server 45 or a client 40 (for example, either one of the n or m clients, or a different client not in one of the clusters 48), and are aggregated for each cluster 48 to generate an aggregated cluster weight 49 for each cluster 48. The aggregated cluster weight 49 for each cluster 48 are then aggregated on the central server 45 or client 40 to generate an aggregated model weight 46 which is then sent to a receiving client 47.

Clients 40 may be arranged into clusters 48 in dependence of the diversity scores for their dataset 41, or diversity weighted model weights 43. Thus, model weights which represent particular domains, for example, images of documents, are aggregated first, before being aggregated with the weights representative of other domains. Thus, an aggregated model weight 46 can be generated more efficiently.

Modifications

It will be appreciated that various modifications may be made to the embodiments hereinbefore described. Such modifications may involve equivalent and other features which are already known in the design and use of methods for federated aggregation and machine learning and component parts thereof and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

What is claimed is:

1. A computer-implemented federated learning method comprising:
for each of a number, n, of clients:
determining a diversity score of a dataset corresponding to that client for training a machine learning model, wherein the diversity score is a measure of dataset variability;
aggregating, weighted by the respective diversity score, models corresponding to each of the clients; and
sending the aggregated model to at least one receiving client.

2. The method of claim 1 wherein aggregating models corresponding to each of the clients comprises:
for each of the number, n, of clients:
assigning each client to a cluster based on one or more dataset attributes;
for each cluster, generating aggregated cluster weights by aggregating, weighted by the respective diversity score, models corresponding to each of the clients; and
aggregating the aggregated cluster weights.

3. The method of claim 2, wherein assigning each client to a cluster comprises:
assigning a cluster identity to the dataset used to train the model.

4. The method of claim 3, wherein assigning the cluster identity to the dataset comprises calculating an vector of softmax probabilities or extracting an embedding vector from a classification model.

5. The method of claim 1, wherein the dataset has been used for training a local model cached on the client.

6. The method of claim 1, further comprising:
for each of the n clients:
applying a differential privacy function to the diversity score weighted model weight.

7. The method of claim 1, wherein the aggregation step(s) are performed on one of the number, n, of clients.

8. The method of claim 1, wherein the aggregation step(s) are performed on a central server.

9. The method of claim 1, wherein the dataset used to train the model comprises image data.

10. The method of claim 1, wherein the dataset used to train the model comprises an input provided by a user.

11. The method of claim 1, wherein the dataset comprises a mask.

12. The method of claim 1, wherein determining the diversity score of the dataset comprises:
determining a scene identity for a subset of the dataset or a data sample.

13. The method of claim 1, wherein in response to a trigger condition the method further comprises, for each data sample:
determining a confidence score of that data sample;
adding the data sample to the dataset if the confidence score is above a threshold; and
discarding the data sample if the confidence score is below the threshold.

14. The method of claim 1, wherein in response to a trigger condition, the method further comprises, for each data sample:
determining a first confidence score for that data sample;
augmenting that data sample;
determining a second confidence score for the augmented data sample;
discarding that data sample if the first and second confidence scores are above a first threshold distance;
if the first confidence score is above a second threshold, adding that data sample to the dataset; and
if the first confidence score is below the second threshold, discarding that data sample.

15. The method of claim 13, wherein determining the confidence score of the data sample further comprises determining the softmax probability for the data sample.

16. The method of claim 13, wherein in response to a trigger condition, the method further comprises, for each data sample:
determining whether the data sample is added to the dataset by comparing an attribute of the data sample to a corresponding attribute a subset of data in the dataset.

17. The method of claim 16, further comprising:
if the distance between the attribute of the data sample and corresponding attribute of the dataset is below a threshold, discarding the data sample; and
if the distance between the attribute of the data sample and corresponding attribute of the dataset is above a threshold, adding the data sample to the dataset.

18. A computer system comprising:
a memory configured to store a dataset; and
at least one processing unit;
wherein the at least one processing unit is configured to:
for each of a number, n, of clients:
determine a diversity score of the dataset corresponding to that client for training a machine learning model, wherein the diversity score is a measure of dataset variability,
aggregate, weighted by the respective diversity score, models corresponding to each of the clients, and
send the aggregated model to at least one receiving client.
